(19) United States
(12) Patent Application Publication
(10) Pub. No.: US 2012/0128832 A1
(43) Pub. Date: May 24, 2012

(54) Organic vegan protein shakes

(76) Inventor: Rogelio A. Smith, Houston, TX (US)

(21) Appl. No.: 12/927,760

(22) Filed: Nov. 22, 2010

(51) Int. Cl. A23L 2/66; B65D 85/72

(52) U.S. Cl. 426/106; 426/590

(57) ABSTRACT

The present invention relates to Organic Vegan Protein sports drinks and shakes formulated from 100% organic and natural plant-based ingredients with the highest grade of protein, vitamins, minerals and other nutrients. The Organic plant proteins used in the drinks and shakes are predominantly, Organic Hemp Powder, Organic Pea Powder and Organic Vegan powder (made from a mixture of Organic seed sprouts). Organic Soy milk and Organic Almond milk provide additional sources of proteins in the shakes. The shakes are packaged in ready to drink (R-T-D) tetra pack containers.

### FIELD OF THE INVENTION

This invention generally relates to sports drinks and shakes. More particularly, the invention relates to ready to drink organic vegan protein sports drinks and shakes for use by athletes and body builders.

### BACKGROUND OF THE INVENTION

The sports drink market has seen a steady increase worldwide, more specifically in the United States where the alarming rate of obesity among the population is sending young and old scurrying to the neighborhood gyms to lose those extra pounds through exercise. With exercise comes the need for diet change and wholesome supplements to replenish critical nutrients lacking in those diets.

Replacing the body's daily requirements of nutrients become a difficult task for individuals who have to eat and run because of their hectic day to day schedules. This has spawned an industry for the formulation of beverages that are packed with all the nutrients to meet the daily needs of the body for its building and repair. Some of these drinks are prepared for the non-athletes and some for the athletes who need to replenish their bodies before and after regular or strenuous exercise.

The current focus of the sports drink market is on protein-based drinks and shakes. A predominantly protein-based drink or shake is preferred by the professional athlete and body builder compared to drinks that are predominantly carbohydrate-based because of the role of proteins, and their building blocks, the amino acids, in the building and repair of muscle tissue that breaks down during strenuous exercise. For a body builder in particular a higher protein intake is required to achieve a net positive gain in muscle mass.

A vast majority of protein-based sports drinks and shakes in the market and in their development stages focus on animal based proteins, more specifically, milk proteins such as whey proteins and casein. U.S. Pat. No. 7,799,363 to Sherwood et al; describes a carbonated protein beverage preferably using whey protein. US Pat. Appl. Pub. No. 2008/0193601 to Nasser also uses whey protein to prepare a sport drink. Intl. Pat. Appl. Pub. No. DE20216946 describes a sports drink using sweet whey powder as its primary protein source. A carbonated sport beverage using whey protein hydrolysates is described in Intl. Pat. Appl. Pub. No. GB2335134 and whey powder protein is used in a sport and energy drink in Intl. Pat. Appl. Pub. No. DE19717195.

Although animal proteins have a high protein efficiency ratio (PER) compared to plant proteins, these proteins impose more stress on the kidneys than the plant proteins. In addition, the current trend among both regular and professional athletes is a preference for plant based proteins, more specifically organic plant proteins in sports drinks and shakes.

The present invention relates to predominantly protein-based sports drinks and shakes that use organic vegan ingredients devoid of animal protein, artificial flavors, preservatives and refined sugar.

### SUMMARY OF THE INVENTION

The present invention relates to protein drinks and shakes formulated to meet the needs of the average athlete as well as the most dedicated body builder, vegan and non-vegan. The drinks of the present invention are made from 100% organic and natural plant based ingredients using the highest grade proteins, vitamins, minerals, and other nutrients and devoid of animal products. The organic vegan sources of the protein are predominantly derived from Organic Soy Milk, Organic Almond Milk, Organic Hemp Powder, and Organic Pea Protein Powder. In addition to the organic plant proteins, the sports shakes also have added vitamins, minerals and other nutrients in the right proportions for the average athlete and the power lifters and body builders, and come in a variety of flavors. The organic vegan protein shakes of the present invention are packaged in a ready to drink form in 17 fl oz (500 ml) tetra pack containers for ease of use, transportation and storage.

### DETAILED DESCRIPTION OF THE INVENTION

The organic vegan protein sports drinks and shakes of the present invention are predominantly formulated in three embodiments to meet the needs of the average athlete and the professional body builder. The drinks are formulated from 100% organic and natural plant-based ingredients with the highest grade of protein, vitamins, minerals and other nutrients. The ready to drink (R-T-D) protein shakes of the embodiments of the invention are meant for use as protein supplements and not meal replacements.

In an exemplary embodiment of the invention, an organic vegan protein ready to drink (R-T-D) shake is formulated with a high concentration of plant protein derived from Organic Hemp Powder. This embodiment is specifically meant for use by the athlete whose goal is to build muscle and body mass. The total protein composition derived from organic plant sources for this shake is given in Table 1. The total protein composition of the shake of this embodiment is 47 g of which 30 g is Organic Hemp Powder. It is recommended that a professional body builder consume a protein shake of this embodiment every six hours, with two or three shakes a day for maximum results.

TABLE 1
R-T-D Organic Hemp Protein Shake

| Ingredients | Protein weight (g) | Protein weight (%) |
|---|---|---|
| Organic Hemp Powder* | 30.0 | 46.0 |
| Organic Soy Milk | 16.0 | 48.0 |
| Organic Flax Oil | 0 | 0.5 |
| Organic Hemp Oil | 0 | 0.5 |
| Organic Maca Powder | 1.0 | 2.0 |
| Vegan Creatine | 0 | 2.0 |
| Vegan L-Glutamine | 0 | 1.0 |
| Total Protein: | 47 g | |

*Hemp powder is a natural fiber product of the Cannabis sativa plant. Raw certified organic hemp is used devoid of hexane, gluten, dairy, lactose or artificial sweeteners. Hemp powder contains all the essential amino acids and essential fatty acids necessary to maintain healthy human life (Isoleucine, leucine, Lysine, Methionine, Phenylalanine, Threonine, Tryptophan, Valine, Histidine, Tyrosine, and Selenocysteine).

In another exemplary embodiment of the present invention, an organic vegan protein ready to drink (R-T-D) shake is formulated using a high concentration of protein derived from Natural Pea Powder. The total protein composition derived from plant sources for this embodiment of the invention is given in Table 2. The total protein composition of the shake of this embodiment is 59 g of which 56 g is from Natural Pea Powder.

TABLE 2
R-T-D Organic Pea Protein Shake

| Ingredients | Protein Weight (g) | Protein Weight (%) |
|---|---|---|
| Natural Pea Powder | 56.0 | 46.0 |
| Organic Almond Milk | 2.0 | 48.0 |
| Organic Flax Oil | 0 | 0.5 |
| Organic Hemp oil | 0 | 0.5 |
| Organic Maca Powder | 1.0 | 2.0 |
| Vegan Creatine | 0 | 2.0 |
| Vegan L-Glutamine | 0 | 1.0 |
| Total Protein: | 59 g | |

In yet another exemplary embodiment of the present invention, an organic vegan protein ready to drink (R-T-D) shake is formulated using natural unflavored vegan protein powder composed of an Organic RAW Sprout Blend (21,925 mg): (Organic Sprouted Brown Rice Protein, Organic Amaranth Sprout, Organic Quinoa Sprout, Organic Millet Sprout, Organic Buckwheat Sprout, Organic Garbanzo Bean Sprout, Organic Kidney Bean Sprout, Organic Lentil Sprout, Organic Adzuki Bean Sprout, Organic Flax Seed Sprout, Organic Sunflower Seed Sprout, Organic Pumpkin Seed Sprout, Organic Chia Seed Sprout, Organic Sesame Seed Sprout). RAW Probiotic and Enzyme Blend (270 mg) (High Protein Chlorella, Proteases, Bacillus subtilis). Other Ingredients: Saccharomyces cerevisiae, Lactobacillus bulgaricus. In this embodiment of the invention, the total protein composition in the shake would be 35 g, of which 18 g is natural unflavored vegan powder. The total protein composition of this embodiment of the invention is given in Table 3.

TABLE 3
R-T-D Unflavored Protein Shake

| | Protein | Protein |
|---|---|---|
| Ingredients | Weight (g) | Weight (%) |
| Natural Unflavored Vegan Powder | 18.0 | 46.0 |
| Organic Soy Milk | 16.0 | 48.0 |
| Organic Flax Oil | 0 | 0.5 |
| Organic Hemp Oil | 0 | 0.5 |
| Organic Maca Powder | 1.0 | 2.0 |
| Vegan Creatine | 0 | 2.0 |
| Vegan L-Glutamine | 0 | 1.0 |
| Total Protein: | 35 g | |

The basic ingredients given in the tables for each embodiments of the present invention are reconstituted with natural water and fortified with vitamins and minerals to meet the optimal daily nutritional requirements. A variety of flavors such as vanilla, chocolate, banana, strawberry etc., are also added to the shakes to provide the athlete with a choice of flavors.

The Organic Soy milk is formulated from filtered water, Organic Whole Soybeans, Organic Naturally Milled Evaporated Cane Juice, Calcium Carbonate, Salt, Organic Vanilla Flavor, Vitamin A Palmitate, Carrageenan, Riboflavin (B2), Vitamin D2, and Vitamin B12. The Organic Almond Milk is formulated from Organic Almond Base (Filtered Water, Organic Almonds) Organic evaporated cane juice, Potassium citrate, Sea salt, Carrageenan, Riboflavin (B2) Vitamin A palmitate and Vitamin D2.

The Maca powder (Lepidium meyenii, walpers) incorporated in the three embodiments of the shakes is derived from natural Peruvian Maca roots and is a certified organic powder. The Hemp oil and Flax oil are 100% raw certified organic oils.

The foregoing description of the present invention through its various preferred embodiments should not be construed to limit the scope of the invention. It should be understood and obvious to one skilled in the art that the embodiments of the invention thus described may be further modified without departing from the spirit and scope of the invention as set forth in the claims that follow.

What is claimed is:

1. An organic vegan protein sports drink comprising:
(a) a vegan protein base selected from the group consisting essentially of organic hemp powder, organic natural pea powder, organic natural unflavored vegan powder, organic soy milk, organic almond milk and mixtures thereof;
(b) an oil base consisting essentially of organic hemp oil and organic flax oil;
(c) supplements consisting essentially of organic vegan creatine, organic vegan L-glutamine and organic maca root powder; and
(d) natural water.

2. An organic vegan protein sports drink of claim 1 wherein the organic vegan protein sports drinks comprise, organic hemp protein shake, organic pea protein shake and organic unflavored protein shake.

3. An organic vegan protein sports drink of claim 1 wherein the organic hemp powder comprises 30 g or 46% of total protein weight in the organic hemp protein shakes.

4. An organic vegan protein sports drink of claim 1 wherein the organic natural pea powder comprises 56 g or 46% of total protein weight in the organic pea protein shakes.

5. An organic vegan protein sports drink of claim 1 wherein the organic natural unflavored vegan powder comprises 18 g or 46% of total protein weight in the organic unflavored protein shakes.

6. An organic vegan protein sports drink of claim 1 wherein the organic soy milk comprises 16 g or 48% of total protein weight in the organic hemp protein shakes.

7. An organic vegan protein sports drink of claim 1 wherein the organic almond milk comprises 2 g or 48% of total protein weight in the organic pea protein shakes.

8. An organic vegan protein sports drink of claim 1 wherein the organic soy milk comprises 16 g or 48% of total protein weight in the organic unflavored protein shakes.

9. An organic vegan protein sports drink of claim 1 wherein the organic flax oil and hemp oils comprise 0 g each or 2% of the total protein weight in the organic hemp protein shake, the organic pea protein shake and the organic unflavored protein shake.

10. An organic vegan protein sports drink of claim 1 wherein the organic vegan creatine supplement comprises 0 g or 2% of the total protein weight in the organic hemp protein shake, the organic pea protein shake and the organic unflavored protein shake.

11. An organic vegan protein sports drink of claim 1 wherein the supplement L-glutamine comprises 0 g or 1% of the total protein weight in the organic hemp protein shake, the organic pea protein shake and the organic unflavored protein shake.

12. An organic vegan protein drink of claim 1 wherein the organic maca powder supplement comprises 1 g or 2% of the total protein weight in the organic hemp protein shake, the organic pea protein shake and the organic unflavored protein shake.

13. An organic vegan protein sport drink of claim 1 wherein the protein of the organic natural unflavored vegan powder is derived from an Organic RAW Sprout Blend (21,925 mg): (Organic Sprouted Brown Rice Protein, Organic Amaranth Sprout, Organic Quinoa Sprout, Organic Millet Sprout, Organic Buckwheat Sprout, Organic Garbanzo Bean Sprout, Organic Kidney Bean Sprout, Organic Lentil Sprout, Organic Adzuki Bean Sprout, Organic Flax Seed Sprout, Organic Sunflower Seed Sprout, Organic Pumpkin Seed Sprout, Organic Chia Seed Sprout, Organic Sesame Seed Sprout).

14. An organic vegan protein sport drink of claim 2 wherein the organic hemp protein shake, the organic pea protein shake and the organic unflavored protein shake are packaged in ready to drink (R-T-D) tetra pack containers.
